(19) United States
(12) Patent Application Publication
(10) Pub. No.: US 2004/0089459 A1
(43) Pub. Date: May 13, 2004

(54) Flip fire extinguisher bracket for powdered fire extinguishers

(76) Inventor: Larry L. Folks, Intercession, FL (US)

Correspondence Address: Larry L Folks, P.O. Box 59, Intercession-City, FL, 33848, US

(21) Appl. No.: 10/368,297

(22) Filed: Feb. 18, 2003

Related U.S. Application Data
(63) Continuation of application No. 10/281,726, filed on Oct. 28, 2002, now abandoned.

(51) Int. Cl. A62C 11/00

(52) U.S. Cl. 169/30

(57) ABSTRACT

What is different about my invention is that the flip fire extinguisher bracket will turn to different positions not allowing the powder to pack in the bottom of the fire extinguisher. The Fire Marshals office reccomends the powdered fire extinguisher be turned over and beat on the bottom to loosen the powder. The Flip Bracketwill aid in keeping the powder from packing in the bottom of the extinguisher.

This invention relates to a flip fire extinguisher bracket that will aid in the efficency of the portable tank type fire extinguisher and for supporting such extinguisher in a convenient location and can readily be used. According to the Florida Fire Marshals office the powder in this type extinguisher can clog if let set for a long period of time. With the invention of the flip bracket it can be flipped from one side to the other side to keep the powder from packing in the bottom of the extinguisher.

The type of fire extinguisher with which the improved bracket of this invention is concerned, includes a tank having a opening lever and a pivoted handle structure at its upper end. The pivoted handle itself extends generally downward to overlap a peripheral upper edge of the tank itself. The lever on the other hand, extends generally horizonally from the top portion of the extinguisher in a position such that both handle and lever may be grasped simultaneously. With this paticular type extinguisher the lever must swing upwardly for operation.

A bracket structure must enable visibility of the extinguisher parts while at the same time be susceptible of quick and easy removal of the fire extinguisher.

Because of the powder clogging in the bottom of the powdered fire extinguisher it is the goal to provide an improved flip bracket that will increase the effricency of the portable tank type fire extinguisher and if used the extinguisher will be easily removed.

These and other advantages of this invention are attained by the main body of the bracket being able to turn on the wall mount bar. The wall mount bar will be secure on the wall and the main body of the bracket will flip from one side to the other side thus having a flip fire extinguisher bracket.

There is bends in the wall mount bar allowing a wing nut to be in place between the wall where the flip bracket will be mounted and the wall mount bar. The wing nut will be on the bolt that holds the wall mount bar to the main body of the bracket.

A better understanding of the invention will be had by now referring to a preferred embodiment thereof as illustrated in the accompaning drawings in which:

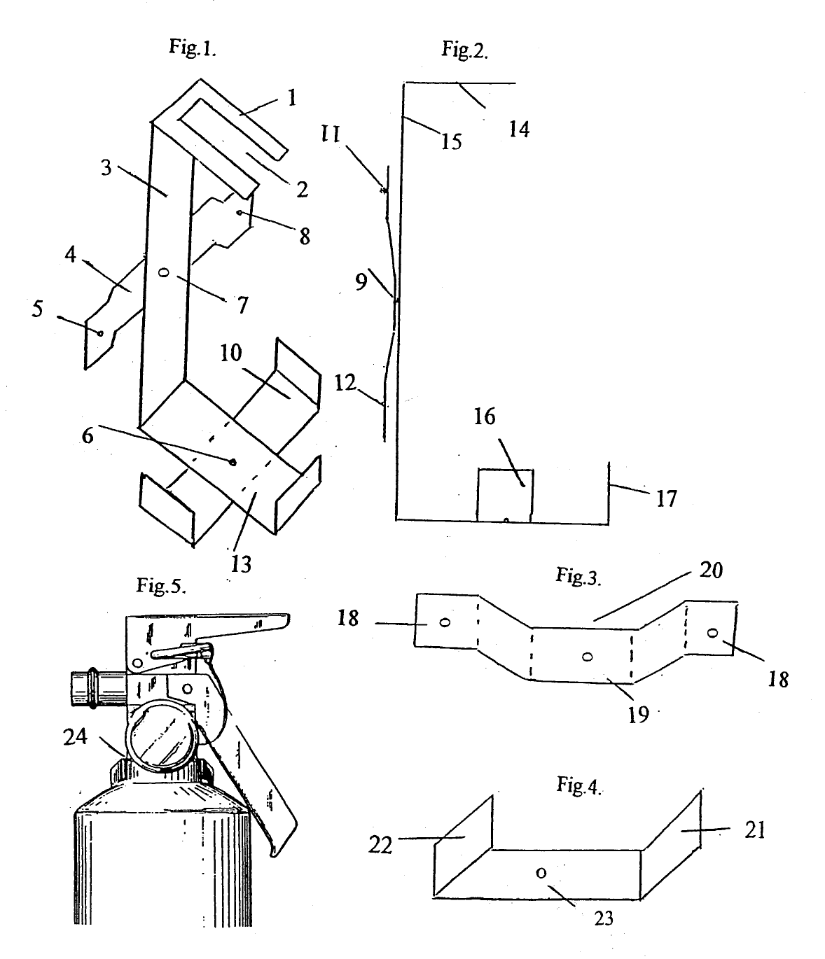

FIG. 1: Is a perspective view illustrating an improved flip bracket of this invention.

FIG. 2: Is an enlarged side view of the wall mount bar and the main body of the bracket.

FIG. 3: Is a view of the wall mount bar.

FIG. 4: Is a view of the bottom support bar.

FIG. 5: Is fragmented view of the upper portion of a portable tank type fire extinguisher

Referring to FIG. 1: Is where the top of the outer section of the bracket holds the extinguisher No. 2: Is where the neck of the extinguisher fits into the top of the flip bracket. No.3 and 13 is the main body of the bracket. No 4: Is the wall mount bar. No 5:and 8 are the holes where you mount the wall mount bar to the wall. No. 6: is the hole where the main body of the bracket is bolted to the bottom support bar. No. 7: is the hole where the main body of the bracket is bolted to the wall mount bar. This is done by using a bolt with a wing nut. The wing nut is between the wall mount bar and wall where the flip bracket will be mounted. This wing nut is what holds tension on the flip bracket while it is being turned from position to another position.

FIG. 2: Is a side view showing the main body of the bracket and the wall mount bar turned at the same angle. No. 14: shows the top of the bracket. No. 15 shows the main body of the bracket. No.16:is the upward bend in the bottom support bar. This is what holds the extinguisher in place while it is being turned from one side to another side. No.17: Is the upward bend in the main body of the bracket that holds the extinguisher secure.

FIG. 3: Is the wall mount bar. No. 18: Is the two holes where the wall mount bar is fastened to the wall. No 19 Is the hole where the main body of the bracket is bolted to the wall mount bar.

FIG. 4: Is the bottom support bar. No 21:and 22 is the two upward bends that cradle the extinguisher at all times and while it is being turned from one position to another position. No 23: Is the hole where the bottom support bar is bolted to the main body of the bracket.

FIG. 5: Is the upward portion of the portable tank type fire extinguisher. No. 24 shows where the flip bracket fits around the neck of the extigguisher.

The entire flip bracket assembly is simple and reliable and will support the extinguisher in a position in which the opening lever and handle portion are clearly visible and manually accessible where by mininum time is required for thr removal of the extinguisher.

1: What I claim that is different about my invention of the flip fire extinguisher bracket is that it will turn to different positions not allowing the powder to pack in the bottom of the extinguisher.
